(19) United States
(12) Patent Application Publication
(10) Pub. No.: US 2026/0295895 A1
(43) Pub. Date: Oct. 1, 2026

(54) ASSISTIVE WOOD SPLITTING DEVICE

(71) Applicant: Glen Salmon, Unionville, IN (US)

(72) Inventor: Glen Salmon, Unionville, IN (US)

(21) Appl. No.: 19/559,206

(22) Filed: Mar. 6, 2026

Related U.S. Application Data
(60) Provisional application No. 63/777,227, filed on Mar. 25, 2025.

(51) Int. Cl. B27L 7/06

(52) U.S. Cl. CPC B27L 7/06

(57) ABSTRACT

A wood splitting system includes a wood splitter including a base plate, and a knife movable in a vertical direction toward and away from the base plate to define a splitting path. The wood splitting system further includes an assistive wood splitting device removably positioned beneath the knife, and including a plurality of beams arranged to form a first opening and a second opening, and a plurality of rollers forming a first series of rollers and a second series of rollers in the first opening and the second opening, respectively, and configured to rotatably support a round of wood in the splitting path defined between the knife and the base plate. A frame for an assistive wood splitting device is also disclosed herein.

### TECHNICAL FIELD

The present disclosure relates generally to wood splitting equipment, and more particularly to an assistive wood splitting device.

### BACKGROUND

In wood splitting applications, a “round” refers to a section or cross-sectional section of a tree trunk or tree limb that is typically cut into smaller sections for various purposes, for example, for firewood. A common practice is to cut the rounds into sections that are 16-inches in length, which correlates to a typical size for firewood. A standard measure of firewood, commonly known in the wood processing arts as a “rick of wood,” is defined as a stack of cut wood that measures approximately 8 feet long, 4 feet high, and 16 inches deep. This measurement accounts for the volume of firewood, with the 16 inch depth corresponding to the typical length of a round. It should be understood that a rick represents a significant quantity of firewood.

The weight of a round can vary significantly based upon various characteristics of the tree, for instance the size of a tree, the type of tree from which the round is sourced, or still other factors. For example, rounds taken from the base or trunk portion of a tree may be heavier than those taken from higher up in another portion of the tree. This can be due to the increased density of the wood near the base, where the trees growth may be more substantial.

The substantial weight and bulk of the rounds present difficulties during both loading and splitting stages of firewood production, often requiring specialized systems and equipment to process them without significant operator strain. While some hydraulic wood splitting systems may prove useful in some instances, there remain certain limitations with current technologies.

### SUMMARY

In one aspect, a wood splitting system includes a wood splitter including a base plate, and a knife movable in a vertical direction toward and away from the base plate to define a splitting path. The wood splitting system further includes an assistive wood splitting device removably positioned beneath the knife, and including a plurality of beams arranged to form a first opening and a second opening, and a plurality of rollers forming a first series of rollers and a second series of rollers in the first opening and the second opening, respectively, and configured to rotatably support a round of wood in the splitting path defined between the knife and the base plate.

In another aspect, a frame for an assistive wood splitting device includes a frame body defining a rectangular footprint and further includes a first lateral beam, a second lateral beam, and a central beam, and the frame body forming a first opening between the first lateral beam and the central beam, and a second opening between the second lateral beam and the central beam. The frame further includes an anchoring projection extending inside or outside of the rectangular footprint and having a ground anchoring hole formed therein, a plurality of roller holes formed in the first lateral beam, second lateral beam, and central beam, and arranged in sets of two registered holes with the sets in a serial arrangement, and a positioning lip projecting from the frame to couple the frame to a base plate.

In yet another aspect, a support device for splitting wood includes a windowed frame formed by a plurality of beams, and defining a plurality of openings. The support device further includes plurality of rollers positioned in the plurality of openings and arranged in a plurality of series, and a positioning lip attached to the frame and extending outwardly therefrom to support the frame on a base plate of a vertical wood splitter.

### BRIEF DESCRIPTION OF DRAWINGS

FIG. 1 is a perspective view of a wood splitting system, according to one embodiment;

FIG. 2 is another perspective view of the wood splitting system according to an embodiment;

FIG. 3 is a view of a frame for an assistive wood splitting device, according to an embodiment;

FIG. 4 is a view of an assistive wood splitting device, according to an embodiment;

FIG. 5 is a diagrammatic side view of a portion of an assistive wood splitting device, according to an embodiment;

FIG. 6 is a perspective view of a frame for an assistive wood splitting device, according to another embodiment;

FIG. 7 is a perspective view of an assistive wood splitting device, according to an embodiment; and

FIG. 8 is a side view of an assistive wood splitting device, according to an embodiment.

### DETAILED DESCRIPTION

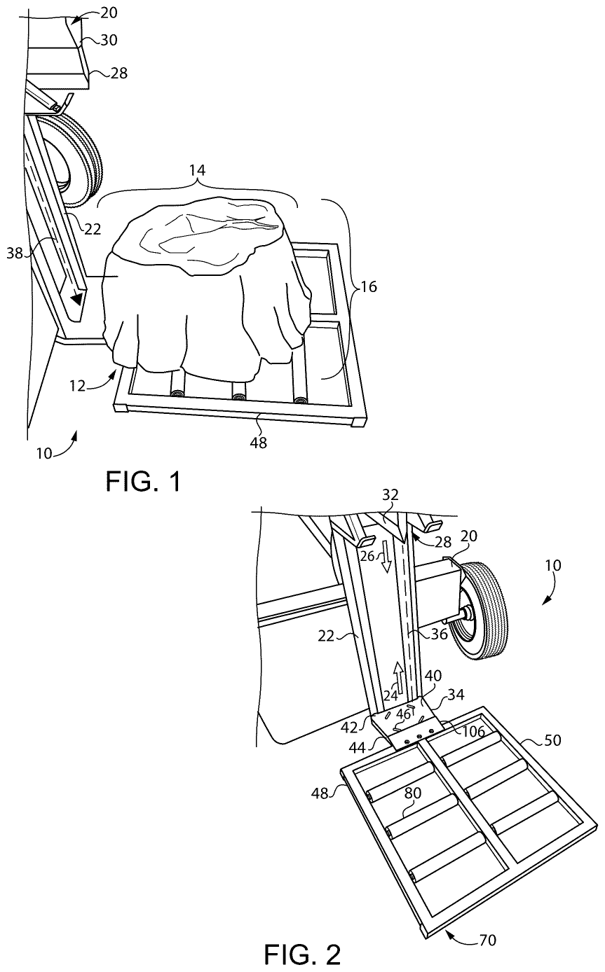

Referring to the drawings generally, but focusing on FIGS. 1 and 2, there is shown a wood splitting system 10, according to one embodiment. Wood splitting system 10 may be suitable for the cutting, processing, and handling of felled trees. Wood splitting system 10 could be used in applications, for instance, in which trees are first felled and then processed into logs or smaller, more manageable pieces, such as a round 12. FIG. 1 illustrates an exemplary round 12. It should be understood that the term “round” denotes a cut cross-sectional portion of wood from a tree, log, or the like, and typically is in a roughly circular or cylindrical shape. Additionally, rounds 12 may vary in at least one of a round diameter 14 or a round length 16 based on various factors such as the size of the tree, species of the tree, or given requirements for a tree cutting operation, to name a few examples. In some instances, rounds 12 taken from a lower or base portion of a tree could have a diameter ranging from approximately 24 inches to 40 inches in diameter, or more, and can often be quite heavy for an operator to handle.

To this end, wood splitting system 10 may include a wood splitter 18. Wood splitter 18 may be a stationary style splitter, a tractor-mounted splitter, or a tow-behind splitter coupled to a machine, such as a vehicle, via a ball coupler and safety chains. As shown in FIGS. 1-3, wood splitting system 10 includes a vertical wood splitter 20. Vertical wood splitter 20 may include a splitter support body 22. Vertical wood splitter 20 may be structured to utilize hydraulic pressure to apply splitting force in a first direction 24 or a second direction 26 thereby enabling splitting of rounds 12.

Vertical wood splitter 20 may further include a knife 28, which could potentially be mounted to a hydraulic ram 30. The term “knife 28” as used herein, should be understood by one of ordinary skill in the art to refer to a wood splitting member configured to penetrate and separate wood fibers. By way of example, knife 28 may include a splitting wedge 32, or some other wedge-shaped splitter head or cleaving wedge. Hydraulic ram 30 may be structured to apply downward force in second direction 26 to knife 28, which drives into rounds 12 thereby splitting them, or forming smaller pieces of wood. While the present wood splitting system 10 is described as using a hydraulic ram to drive knife 28, in other examples, the driving mechanism may be a flywheel system, or some other cutting strategy.

Vertical wood splitter 20 may further include a base plate 34 structured to receive rounds 12, and facilitate the alignment of rounds 12 beneath knife 28. A splitting clearance 36 is defined between base plate 34 and knife 28. The splitting clearance 36 may vary when knife 28 is in upmost position. During operation, knife 28 may be movable in a vertical direction toward and away from base plate 34 to define a splitting path 38 within splitting clearance 36, to accommodate rounds 12 of varying sizes.

Base plate 34 may form a platform having a base plate surface 40 extending from an inner base plate end 42 coupled to splitter support body 22, to an outer base plate end 44. Base plate 34 may be configured to support the hydraulic or splitting force delivered by knife 28 during a splitting operation. In a practical implementation, base plate 34 may also include wood gripping projections 46 to help stabilize rounds 12 during splitting operations by preventing undesired lateral movement.

Wood splitting system 10 may also utilize a support device for splitting wood, such as an assistive wood splitting device 48 (hereinafter, “assistive device 48”). FIGS. 1 and 2 illustrate assistive device 48 removably positioned beneath knife 28. As will become further apparent from the forthcoming discussion, assistive device 48 may reduce the manual effort required to move, position, or otherwise maneuver the heavy rounds 12, such that an operator can efficiently process large and heavy rounds into split firewood without undue physical strain.

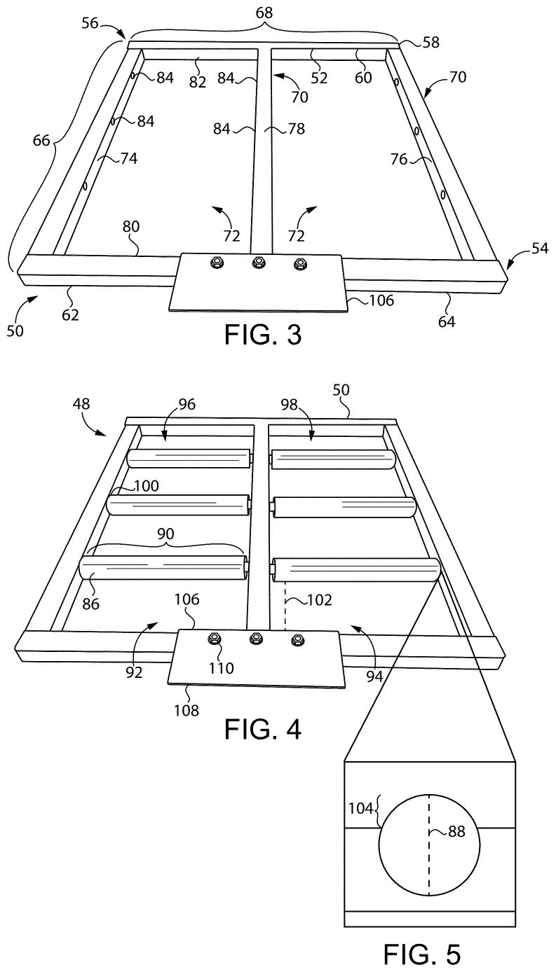

Referring now to FIGS. 3 and 4, there are additional features shown of the support device. Assistive device 48 may be formed from a metallic material such as aluminum, steel, titanium, or still other metals and/or metallic alloys. Assistive device 48 may include a frame 50 having a frame body 52. Frame body 52 may extend from a front frame end 54 to a back frame end 56, and includes an upper side 58 having an upper frame surface 60, and a lower side 62 having a lower frame surface 64.

Frame 50 may also define a length dimension 66, and a width dimension 68 which could be the same or different from length dimension 66. In a practical example, length dimension 66 may range from approximately 24 inches to approximately 48 inches and width dimension 68 may range from about 24 inches to about 48 inches. The term “approximately,” as used hereinafter denotes a parameter which may vary by an amount that would be understood by one of ordinary skill in the art. For instance variation may arise from, for example, manufacturing tolerances, material properties, or assembly conditions. Frame body 52 may define a rectangular footprint, and may be a windowed frame. For instance, frame 50 may include a plurality of beams 70 defining one, or potentially a plurality of openings 72.

Frame 50 may also include a first outer, or lateral, beam 74, a second outer, or lateral, beam 76, and a central support beam 78 located between first lateral beam 74 and second lateral beam 76. Frame 50 may also include a front beam 80 located at front frame end 54 and a back beam 82 located at back frame end 56. Each of front beam 80 and back beam 82 may extend from first lateral beam 74 to second outer beam 76.

As shown in FIG. 3, frame 50 may further include a plurality of roller holes 84 formed in the first lateral beam 74, second outer beam 76, and central beam 78. Each roller hole 84 may be drilled or machined into the respective beam 70. The plurality of roller holes 84 may be arranged in sets of two registered holes with the sets in a serial arrangement. Assistive device 48 may also include a plurality of rollers 86. Each roller 86 may be engaged in a respective roller hole 84 set. Rollers 86 may be made from a durable material such as stainless steel, but are not limited to such and alternative materials are contemplated. In one example, each roller 86 may have the capacity to support at least a 100 pound load. Rollers 86 may be cylindrical in shape, and may be at least 1 and ½ inches in roller diameter 88 and at least 10 inches in roller length 90.

As mentioned above, frame 50 includes openings 72. The plurality of rollers 86 may be positioned in the plurality of openings 72 and arranged in a plurality of series. As shown in FIG. 3, the plurality of beams 70 may be arranged to form a first opening 92 and a second opening 94. First opening 92 may be between first lateral beam 74 and central beam 78, and second opening 94 may be between second lateral beam 76 and central beam 78.

In one practical example, the plurality of rollers 86 may include a total number of 6 rollers, but is not limited to such. In this example, the plurality of roller holes 84 includes at least 3 sets of roller holes in the respective beams forming first opening 92 and at least 3 sets of roller holes in the respective beams forming the second opening 94. Rollers 86 may also be arranged in a number of series, for instance, rollers 86 may be arranged to form a first series of rollers 96 and a second series of rollers 98 in first opening 92 and the second opening 94, respectively, to rotatably support rounds 12 of wood in splitting path 38. Each roller 86 may include a spring-loaded roller 100. In other examples contemplated, each roller 86 could be secured by a fastener, such as a clip or a pin.

A roller distance 102 may be defined between each roller 86. For instance, each roller 86 may be positioned approximately an equal distance away from one another. In a practical implementation, each roller may be spaced approximately 6 inches apart. In other implementations, first series of rollers 96 are aligned with second series of rollers 98. Each roller 86 may include a rise 104 extending upwardly above upper frame surface 60. Rise 104 may form a clearance approximately 1 and ¼ inches above upper frame surface 60. The slight extension of rollers 86 above frame 50 may allow guiding of rounds 12 into splitting path 38. In other embodiments, one or more rollers 86 may have a differing diameter and/or spacing.

Assistive device 48 may also include a positioning lip 106 attached to frame 50 and configured for coupling assistive device 48 to base plate 34. As mentioned above, frame body 52 may define a rectangular footprint. Positioning lip 106 may project from frame 50 to a positioning lip edge 108 outside of the rectangular footprint. Positioning lip 106 may form a platform, and can support frame 50 on base plate 34 under the splitting force of vertical wood splitter 20.

As shown, positioning lip 106 is attached to upper frame surface 60. In other embodiments, positioning lip 106 may be connected to front beam 80, or potentially back beam 82. Positioning lip 106 may be attached to frame 50 via fasteners 110, such as bolts, but is not limited to such and other strategies for attaching positioning lip 106 to frame 50 are contemplated, as further discussed subsequently. Positioning lip 106 may work in tandem with base plate 34 to distribute the splitting force applied to assistive device 48. Without positioning lip 106, for instance, during splitting operations rounds 12 could, for example, contact rollers 86 directly, subjecting them to forces that would, crush, deform, or otherwise damage components of wood splitter 18 thereby compromising performance.

Rollers 86 may be set back from positioning lip 106, such that the subsequent roller 86 set, which immediately follows positioning lip 106 may be spaced at a distance from front beam 80. In a practical example, this set back could be approximately 6 inches from front beam 80. The set back arrangement may direct the hydraulic force and weight of knife 28 largely onto positioning lip 106 and base plate 34.

As suggested above, utilizing assistive device 48, an operator could employ rollers 86 to maneuver rounds 12 by allowing rollers 86 to rotate. Another way to understand this principle is that movement patterns can be varied in a manner that allows for different configurations, where individual rollers, pairs of rollers, or multiple rollers in unison may be actuated to achieve desired movement. To this end, assistive device 48 may be able to accommodate a variety of movement patterns, which could include, but are not limited to the motion of a single roller, two rollers, or a plurality of rollers moving simultaneously.

The combined action of knife 28 and operator-controlled maneuvering of the wood may result in a controlled splitting process. As shown in FIG. 1, round 12 is positioned in an upright position beneath knife 28. During a splitting operation, knife 28 can be employed to make a first cut, thereby dividing round 12 into two halves or parts. It should be understood that an operator could additionally manipulate the position of the wood using rollers 86 if required to complete the first cut. Subsequently, round 12 may be easily maneuvered by an operator, utilizing rotation of rollers 86 to reposition the wood to make a second cut, thereby dividing the halves into quarters. Once the smaller sections of wood are formed, each section may be further processed for various purposes. For example, the smaller sections may be used as firewood, transported to other locations for additional processing, or ricked, meaning stacked in an arrangement to promote airflow.

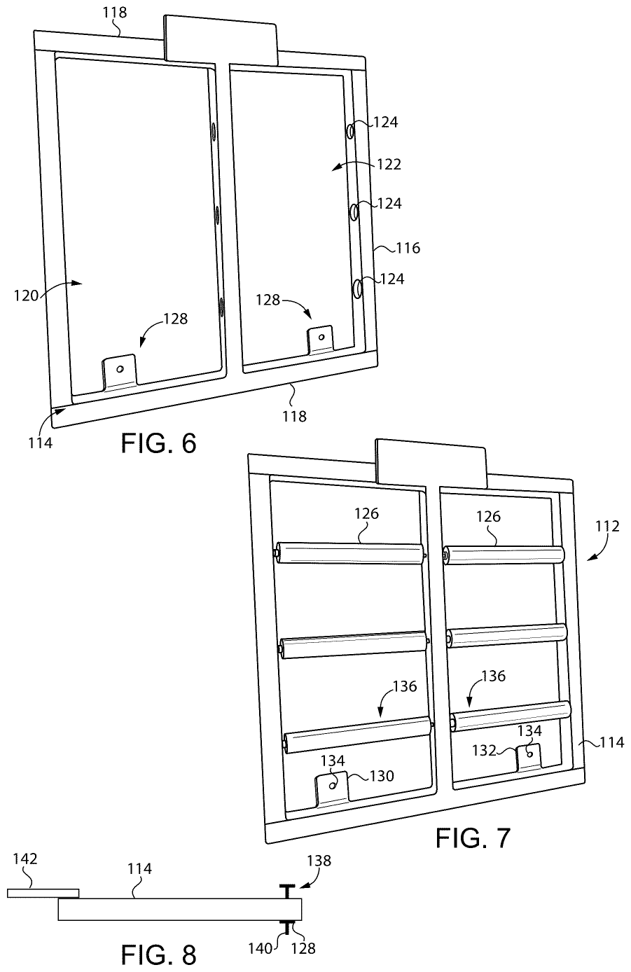

Referring now to FIGS. 5 and 6, there is shown features for an assistive device 112, according to another embodiment. The forthcoming description of assistive device 112 should be understood to be generally analogous to the description of assistive device 48, except where specified otherwise. Assistive device 112 may include a frame 114 having a frame body 116 defining a rectangular footprint. Frame 114 may also include a plurality of beams 118 arranged to form a first opening 120 and a second opening 122, sets of registered roller holes 124, and serially arranged rollers 126 and engaged in each roller hole 124 set.

When wood is placed on assistive device 48 for chopping, the impact of knife 28 striking and/or entering a given round 12 can impart reaction forces that may cause assistive device 48 to shift, slide, rock, or otherwise move relative to the underlying ground surface. To this end, assistive device 48 may include one or a plurality of anchoring projections 128 connected to frame 114. In a practical implementation, frame 114 may include a first anchoring projection 130 and a second anchoring projection 132. Additional numbers of anchoring projections are contemplated.

As illustrated, each anchoring projection 128 is connected to back beam 82, and positioned on an opposite end from a positioning lip 142. Anchoring projections 128 may be connected on the lower side 62. Assistive device 48 may further include one or a plurality of ground anchoring holes 134 adjacent to a terminal roller set 136. In a practical implementation, each of the respective anchoring projections 128 includes at least one of grounding anchoring hole 134 formed therein.

As mentioned above, frame 114 may define a rectangular footprint. Anchoring projections 128 may extend inside or outside of the rectangular footprint. As shown, each anchoring projection 128 extends in at least one of first opening 120 or the second opening 122. Wood splitting system 10 may further include anchors 138 configured to engage with anchoring projection 128 to hold assistive device 48 down and affix it to a ground surface. By way of example, anchors 138 include grounding spikes 140. In other embodiments, anchoring strategies may be separate from device.

### INDUSTRIAL APPLICABILITY

It will be recalled that assistive device 48,112 may include frame 50,114 having a plurality of beams 70,118. Assistive device 48,112 may also include rollers 86,126 arranged in series, and positioning lip 106,142. Assistive device 48,112 may be suitable for in-field wood splitting operations and may provide a practical solution for various outdoor applications, for instance, where traditional machinery may not be accessible and rounds 12 are heavy enough that additional assistance is required.

In a practical example, assistive device 48,112 could, for instance, be sold disassembled where each of the respective beams 70,118, rollers 86,126, and positioning lip 106,142 would come packaged in a box and clearly organized for easy assembly. Along with each component, the packaged box could include necessary fasteners to attach each beam in addition to other components.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A wood splitting system comprising:
a wood splitter including a base plate, and a knife movable in a vertical direction toward and away from the base plate to define a splitting path;
an assistive wood splitting device removably positioned beneath the knife, and including a plurality of beams arranged to form a first opening and a second opening; and
a plurality of rollers forming a first series of rollers and a second series of rollers in the first opening and the second opening, respectively, and configured to rotatably support a round of wood in the splitting path defined between the knife and the base plate.

2. The wood splitting system of claim 1 wherein the assistive wood splitting device further includes a frame, and a positioning lip attached to the frame and coupling the assistive wood splitting device to the base plate.

3. The wood splitting system of claim 2 wherein the assistive wood splitting device further includes anchoring projections, and further comprising anchors configured to engage with the anchoring projections to affix the frame to a ground surface.

4. The wood splitting system of claim 3 wherein each of the anchoring projections extends into at least one of the first opening or the second opening.

5. The wood splitting system of claim 3 wherein each of the anchoring projections includes a ground anchoring hole formed therein.

6. The wood splitting system of claim 5 wherein the anchors include grounding spikes.

7. The wood splitting system of claim 1 wherein each of the plurality of rollers are equally spaced apart, and the first series of rollers are aligned with the second series of rollers.

8. The wood splitting system of claim 7 wherein the plurality of rollers includes a total number of 6.

9. A frame for an assistive wood splitting device comprising:
a frame body defining a rectangular footprint and including a first lateral beam, a second lateral beam, and a central beam, and the frame body forming a first opening between the first lateral beam and the central beam, and a second opening between the second lateral beam and the central beam;
an anchoring projection extending inside or outside of the rectangular footprint and having a ground anchoring hole formed therein;
a plurality of roller holes formed in the first lateral beam, second lateral beam, and central beam, and arranged in sets of two registered holes with the sets in a serial arrangement; and
a positioning lip projecting from the frame to couple the frame to a base plate.

10. The frame for the assistive wood splitting device of claim 9 wherein the frame body further includes a front beam and a back beam, each extending from the first lateral beam to the second lateral beam, the positioning lip is connected to the front beam, and the anchoring projection is connected to the back beam.

11. The frame for the assistive wood splitting device of claim 10 wherein the frame body further includes an upper side and a lower side, and the anchoring projections are connected on the lower side, and the positioning lip is connected to the upper side.

12. The frame for the assistive wood splitting device of claim 9 wherein the anchoring projection extends inside of the rectangular footprint, and the positioning lip extends from the frame to a positioning lip edge outside of the rectangular footprint.

13. The frame for the assistive wood splitting device of claim 12 wherein the anchoring projection includes a ground anchoring hole formed therein.

14. The frame for the assistive wood splitting device of claim 13 further comprising a second anchoring projection.

15. The frame for the assistive wood splitting device of claim 14 wherein the plurality of roller holes includes at least 3 sets of roller holes in the respective beams forming the first opening and at least 3 sets of roller holes in the respective beams forming the second opening.

16. A support device for splitting wood comprising:
a windowed frame formed by a plurality of beams, and defining a plurality of openings;
a plurality of rollers positioned in the plurality of openings and arranged in a plurality of series; and
a positioning lip attached to the frame and extending outwardly therefrom to support the frame on a base plate of a vertical wood splitter.

17. The support device of claim 16 wherein the plurality of openings includes a first opening and a second opening, and the plurality of rollers are in the first opening and the second opening and arranged in a total number of 2 series.

18. The support device of claim 16 wherein the plurality of rollers are arranged in sets having a serial arrangement, each set including a first roller in the first opening and a second roller in the second opening.

19. The support device of claim 18 wherein the windowed frame further includes a plurality of ground anchoring holes positioned adjacent to a terminal roller set.

20. The support device of claim 19 wherein the plurality of rollers includes a total number of 6 rollers, and each roller is a spring-loaded roller.
